(19) United States
(12) Patent Application Publication
(10) Pub. No.: US 2015/0300022 A1
(43) Pub. Date: Oct. 22, 2015

(54) Tapered Sleeve Locking Type Reinforcing Bar Connecting Joint and its Mounting Tool

(71) Applicant: Xinmin WANG, Jiaozhou City (CN)

(72) Inventors: Xinmin Wang, Jiaozhou City (CN); Wenyu Wang, Jiaozhou City (CN); Liqiang Tian, Jiaozhou City (CN); Hufeng Zhao, Jiaozhou City (CN)

(21) Appl. No.: 14/417,271

(22) PCT Filed: Jan. 26, 2014
(86) PCT No.: PCT/CN2014/000102

§ 371 Date: Jan. 26, 2015

(30) Foreign Application Priority Data
Dec. 20, 2013 (CN) 201310743064.6
Jan. 13, 2014 (CN) 201410013110.1

(51) Int. Cl. E04C 5/16; B25B 27/02

(52) U.S. Cl. CPC E04C 5/165; B25B 27/023; B25B 27/026

(57) ABSTRACT

The present invention discloses a tapered sleeve locking type reinforcing bar connecting joint and its mounting tool. The tapered sleeve locking type reinforcing bar connecting joint provided comprises a locking sheet set and tapered sleeves, the locking sheet set is as a whole in shuttle shape and is provided with a tooth groove for locking inside it, the tapered sleeves is provided in pair, with its inner chamber in tapered shape, and the pair of the tapered sleeve is symmetrically mounted around the locking sheet set. The mounting tool comprises pressing heads and a power device fixedly connected or slidably coordinating with the pressing heads, the pressing heads is provided in pair, and one end of the pressing head is designed as opening, the diameter of the opening end being greater than that of the reinforcing bars to be connected and smaller than that of the tail end of the tapered sleeve. In the present invention, the snapping of the locking sheet set at the reinforcing bars and the fixation between the tapered sleeves and the locking sheet set are realized by inclined-plane self-locking principle. It is simple in structure, convenient in handing, greatly reducing the labor of operators, improving the production efficiency, and the connection is reliable without loose.

### TECHNICAL FIELD

The present invention belongs to the field of reinforcing bar connecting techniques, particularly to a tapered sleeve locking type reinforcing bar connecting joint and a tool mounting the joint.

### BACKGROUND ART

In manufacture fields such as buildings, metal wires often need to be connected, for example, in building construction, problems of interconnection between reinforcing bars are often encountered, generally by welding. The ends of adjacent two reinforcing bars are welded and fixed together, and welding equipment is required when welding. In construction site, workers often work at high altitude, so it is very difficult to use welding equipment because of space limitation by the site, with significant potential safety hazard, and a lot of energy is consumed by welding, which makes the environment polluted greatly. In addition, the interface of welding is insufficiently strong, easily getting rusty and the welding open.

In recent years, there emerges a reinforcing bar connecting device without welding, the device makes threaded connection, wherein the ends of adjacent two reinforcing bars are threaded and then connected by a long nut. The threaded connection manner is complex in process, and the threads need to be tapped in advance or on spot using special equipment for tapping threads on reinforcing bars, which still has potential safety hazard. In addition, since the reinforcing bars are relatively long, tapping threads is time-consuming and laborious, with production efficiency low, cost high, which limits its popularity.

### DISCLOSURE OF THE INVENTION

In order to overcome the above mentioned defects in the prior art, the object of the present invention is to provide a tapered sleeve locking type reinforcing bar connecting joint and its mounting tool, which is convenient and efficient for installation, safe for handling, reliable for connection, and low for production cost.

The tapered sleeve locking type reinforcing bar connecting joint provided by the present invention comprises a locking sheet set and tapered sleeves, the locking sheet set is as the whole in shuttle shape which is provided with a tooth groove for locking therein, wherein the tapered sleeves is provided in pair, with its inner chamber in tapered shape, and the pair of the tapered sleeve is symmetrically mounted around the locking sheet set. One pair of tapered sleeves is provided, and a method of compressing the tapered sleeves is applied, in which the locking sheet set tightly snaps at the reinforcing bars by means of the tooth groove under the tightening up action of the inclined-planes of the tapered sleeves; at the same time, fixation between the tapered sleeves and the locking sheet set is realized by inclined-plane self-locking principle, thus achieving the connection of the reinforcing bars. The connecting joint is simple in structure, convenient in handing and reliable in connection.

The locking sheet set is further provided with a boss inside it, and the boss is arranged on the centre position of the inner surface of the locking sheet set. The design of the boss ensures the positioning of the ends of the two reinforcing bars to be connected within the locking sheet set.

The mounting tool for mounting the tapered sleeve locking type reinforcing bar connecting joint provided by the present invention comprises pressing heads and a power device fixedly connected or slidably coordinating with the pressing heads, the pressing heads are provided in pair, and one end thereof is designed as open, the diameter of the opening being greater than that of the reinforcing bars to be connected and smaller than that of tail end of the tapered sleeve. The design of the open end makes the mounting tool convenient in use, facilitating the mounting tool to snap with the reinforcing bars and be removed after installation.

The power device fixedly connected with the pressing heads comprises a hydraulic controlling mechanism and a pulling rod, and the hydraulic controlling mechanism and the pulling rod are fixedly connected as one unity and fixedly provided between the other ends of the two pressing heads. The hydraulic controlling mechanism may be a mechanism including a hydraulic cylinder and a return spring, one end of the return spring is fixed to the bottom of body of the hydraulic cylinder, the other end is fixed to one end of a piston of the hydraulic cylinder, and the pulling rod is fixedly connected to the other end of the piston of the hydraulic cylinder. The hydraulic cylinder is provided with one inlet-outlet opening for hydraulic oil, which may be connected with a manual or electric hydraulic pump, realizing output of the hydraulic oil. The hydraulic controlling mechanism may also be a hydraulic cylinder providing with two inlet-outlet openings for hydraulic oil, and the pulling rod is fixedly connected to one end of a piston of the hydraulic cylinder, the inlet-outlet openings for hydraulic oil may be connected with a manual or electric hydraulic pump, and a reversing valve is needed to be installed between the hydraulic pump and the inlet-outlet openings for hydraulic oil, realizing output and return of the hydraulic oil.

The power device coordinating with the pressing heads comprises a guide rail, a lead screw, a worm gear and a worm rod, the pressing head coordinates with the guide rail and can move back and forth along the guide rail, one end of each of the pressing head near the guide rail is provided with threads, the directions of the threads on the two pressing heads are opposite, the pressing heads coordinate with the lead screw to form leadscrew-and-nut pairs, both ends of the lead screw are provided with positive and negative trapezoidal threads, respectively, one end of the lead screw is fixedly connected with the worm gear, and the worm gear coordinate with the worm rod to form wormgear-and-wormrod pairs. The worm rod is rotated, driving the worm gear and the lead screw to rotate, and then by means of the transmission of the leadscrew-and-nut pairs, the pressing heads produce axial compression movement and approach to each other, applying axial compression force to the tail ends of the tapered sleeves to be compressed, realizing the purpose of shortening spacing between the two tapered sleeves. The mounting tool is simple in structure and convenient in handing, reducing the labor of operators. One end of the worm rod is provided with square head, which can coordinate with a manual, pneumatic or electric wrench.

The tapered sleeve locking type reinforcing bar connecting joint and its mounting tool provided by the present invention have the following beneficial effects: the snapping of the locking sheet set at the reinforcing bars and the fixation between the tapered sleeves and the locking sheet set are realized by inclined-plane self-locking principle, realizing firm connection of reinforcing bars without other members, and they are simple in structure and convenient in handing, greatly reducing the labor of operators, improving the production efficiency, and the connection is reliable without loose. It is indicated through tensile resistance tests that the tensile strength using such connecting joint considerably exceeds that of a welding structure.

### BRIEF DESCRIPTION OF THE DRAWINGS

FIG. 1 is an overall structural schematic view of Embodiment 1,

FIG. 2 is a schematic view of a mounting tool of FIG. 1 in a closing state,

FIG. 3 is an overall structural schematic view of a tapered sleeve locking type reinforcing bar connecting joint according to the present invention,

FIG. 4 is a structural schematic view of the tapered sleeve of FIG. 3,

FIG. 5 is a structural schematic view of a locking sheet set of FIG. 3,

FIG. 6 is an overall structural schematic view of Embodiment 2,

FIG. 7 is a schematic view of a mounting tool of FIG. 6 in a closing state, and

FIG. 8 is an overall structural schematic view of Embodiment 3.

In the Figures:

1. locking sheet set, 1-1. tooth groove, 1-2. boss, 2. tapered sleeve,

2-1. front end of the tapered sleeve, 2-2. tail end of the tapered sleeve,

3. reinforcing bar to be connected, 4. pulling rod, 5. pressing head,

6. hydraulic cylinder, 6-1. inlet-outlet opening for hydraulic oil,

7. return spring, 8. piston, 9. hydraulic cylinder

9-1. inlet-outlet opening for hydraulic oil, 9-2. inlet-outlet opening for hydraulic oil,

10. piston, 11. pressing head, 12. guide rail, 13. lead screw,

14. worm gear, 15. worm rod.

### DETAILED DESCRIPTION OF THE PREFERRED EMBODIMENTS

A tapered sleeve locking type reinforcing bar connecting joint and its mounting tool provided by the present invention will be described in detail below with reference to the figures in conjunction with three embodiments.

### Embodiment 1

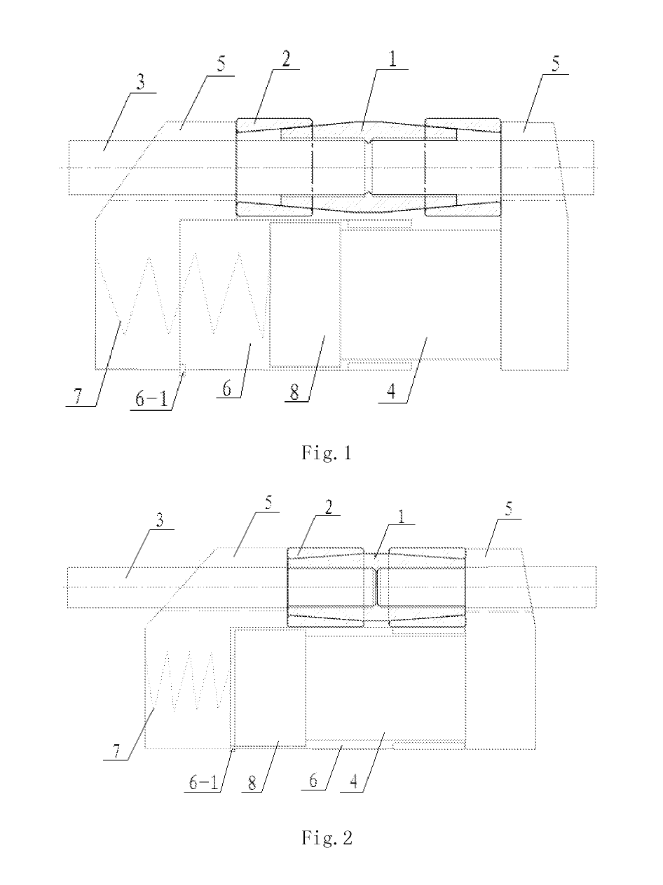

With reference to FIGS. 1 to 5, a tapered sleeve locking type reinforcing bar connecting joint of the present embodiment comprises a locking sheet set 1 and tapered sleeves 2. The locking sheet set 1 is as a whole in shuttle shape and is provided with a tooth groove 1-1 for locking inside it. The tapered sleeves 2 are provided in pair, with its inner chamber in tapered shape, and the pair of tapered sleeves 2 is symmetrically mounted around the locking sheet set 1. The locking sheet set 1 is further provided with a boss 1-2 inside it, and the boss 1-2 is arranged on the centre position of the inner surface of the locking sheet set 1, playing positioning function on reinforcing bars 3 to be connected.

A mounting tool for mounting the tapered sleeve locking type reinforcing bar connecting joint of the present embodiment comprises pressing heads 5 and a power device fixedly connected with the pressing heads 5. The pressing heads 5 are provided in pair, and one end of the press head is designed as opening, the diameter of the opening end being greater than that of the reinforcing bars 3 to be connected, and smaller than that of the tail end 2-2 of the tapered sleeve. The power device comprises a hydraulic controlling mechanism and a pulling rod 4, and the hydraulic controlling mechanism and the pulling rod 4 are fixedly connected as one unity and fixedly provided between the other ends of the two pressing heads 5. The hydraulic controlling mechanism is a mechanism including a hydraulic cylinder 6 and a return spring 7. One end of the return spring 7 is fixed to the bottom of body of the hydraulic cylinder 6, the other end is fixed to one end of a piston 8 of the hydraulic cylinder 6, and the pulling rod 4 is fixedly connected to the other end of the piston 8 of the hydraulic cylinder 6. The hydraulic cylinder 6 is provided with one inlet-outlet opening for hydraulic oil 6-1. The inlet-outlet opening for hydraulic oil 6-1 may be connected with a manual or electric hydraulic pump, realizing output of the hydraulic oil.

The method of connecting the reinforcing bars using the above tapered sleeve locking type reinforcing bar connecting joint and its mounting tool is as follows: (1) the two tapered sleeves 2 are fitted over the ends of the reinforcing bars 3 to be connected, respectively, with the front ends 2-1 of the two tapered sleeves oppositely arranged, then the ends of the reinforcing bars 3 to be connected covered with the tapered sleeves 2 are inserted in both ends of the locking sheet set 1 respectively, such that the ends of the reinforcing bars 3 to be connected are snapped at the boss 1-2 on the inner surface of the locking sheet set 1, and then the tapered sleeves 2 are made to cover the locking sheet set 1 for fixing; (2) the pressing heads 5 of the mounting tool of the present embodiment are fitted over the reinforcing bars 3 to be connected, and once positioned, the inlet-outlet opening for hydraulic oil 6-1 is fed with oil by means of the manual or electric hydraulic pump, the pulling rod 4 is driven by the piston 8 to be retracted toward the inside of the body of the hydraulic cylinder 6, making the pressing heads 5 produce axial compression movement and approach to each other, applying axial compression force to the tail ends 2-2 of the tapered sleeves for compressing, making the tapered sleeves 2 at two sides move axially and shortening the spacing, until satisfying the design requirement, the locking sheet set 1 tightens up and snaps at the reinforcing bars 3 to be connected, and fixation between the locking sheet set 1 and the tapered sleeves 2 is also realized by inclined-plane self-locking principle; and (3) by means of the elastic force of the return spring 7, the piston 8 drives the pulling rod 4 to extends outwards, making the pressing heads 5 move away from each other, and the mounting tool of this embodiment is removed, the firm degree of the connection between the reinforcing bars is checked, thus completing the connection of two reinforcing bars.

### Embodiment 2

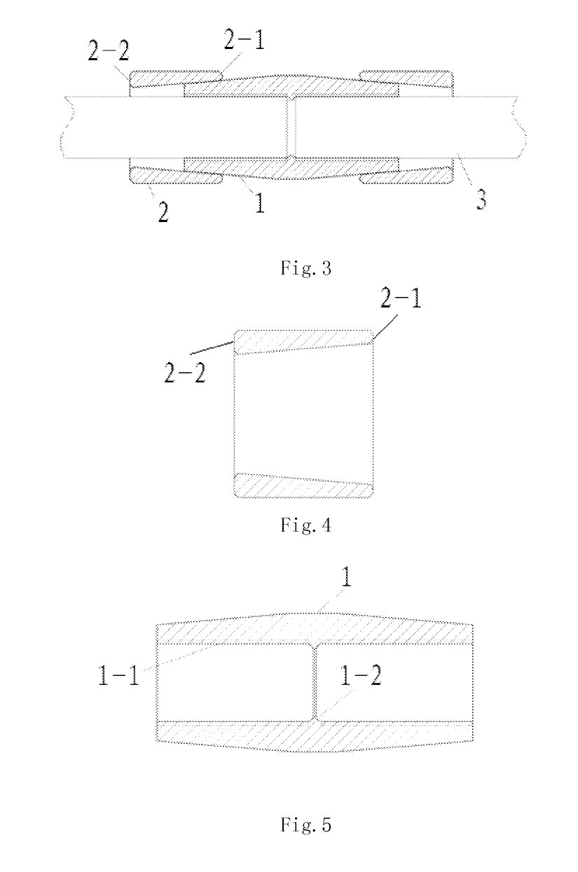

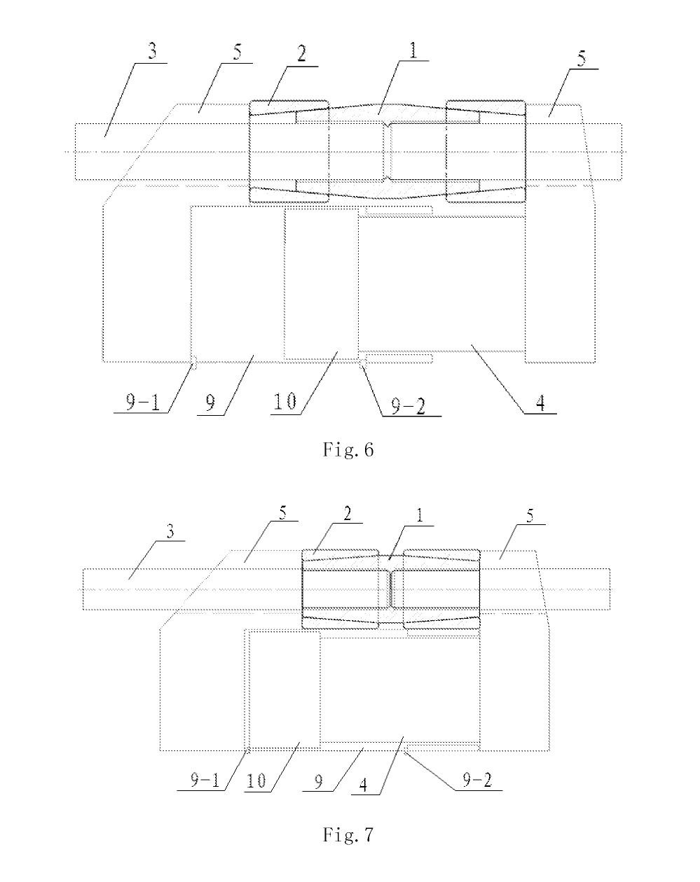

With reference to FIGS. 3 to 7, the differences between the present embodiment and Embodiment 1 lie in that the hydraulic controlling mechanism is a hydraulic cylinder 9 providing with two inlet-outlet openings for hydraulic oil 9-1, 9-2, and the pulling rod 4 is fixedly connected to one end of a piston 10 of the hydraulic cylinder 9. The inlet-outlet openings for hydraulic oil 9-1, 9-2 may be connected with a manual or electric hydraulic pump, and a reversing valve is needed to be installed between the hydraulic pump and the inlet-outlet openings for hydraulic oil 9-1, 9-2, realizing output and return of the hydraulic oil.

The method of connecting the reinforcing bars using the tapered sleeve locking type reinforcing bar connecting joint as described in Embodiment 1 and the mounting tool as described in this embodiment is as follows: (1) the two tapered sleeves 2 are fitted over the ends of the reinforcing bars 3 to be connected, respectively, with the front ends 2-1 of the two tapered sleeves oppositely arranged, then the ends of the reinforcing bars 3 to be connected covered with the tapered sleeves 2 are inserted in both ends of the locking sheet set 1, such that 1 the ends of the reinforcing bars 3 to be connected is snapped at the boss 1-2 on the inner surface of the locking sheet set 1, and then the tapered sleeves 2 are made to cover the locking sheet set 1 for fixing; (2) the pressing heads 5 of the mounting tool of the present embodiment are fitted over the reinforcing bars 3 to be connected, and once positioned, the inlet-outlet opening for hydraulic oil 9-1 is fed oil by means of the manual or electric hydraulic pump, the pulling rod 4 is driven by the piston 10 to be retracted toward the inside of the body of the hydraulic cylinder 9, making the pressing heads 5 produce axial compression movement and approach to each other, applying axial compression force to the tail ends 2-2 of the tapered sleeves for compressing, making the tapered sleeves 2 at two sides move axially to shorten the spacing, until satisfying the design requirement, and the locking sheet set 1 tightens up and is snapped at the reinforcing bars 3 to be connected, and fixation between the locking sheet set 1 and the tapered sleeves 2 is also realized by inclined-plane self-locking principle; and (3) the output direction of the hydraulic oil is changed by the reversing valve, feeding oil to the other inlet-outlet opening for hydraulic oil 9-2, and the piston 10 drives the pulling rod 4 to extend outwards, making the pressing heads 5 move away from each other, and the mounting tool of this embodiment is removed, and the firm degree of the connection between the reinforcing bars is checked, thus completing the connection of two reinforcing bars.

### Embodiment 3

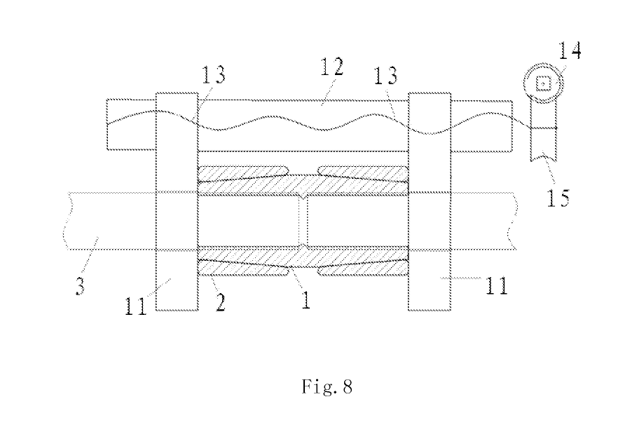

With reference to FIGS. 3 to 5 and FIG. 8, the differences between the present embodiment and Embodiments 1 and 2 lie in that the mounting tool for mounting the tapered sleeve locking type reinforcing bar connecting joint of the present embodiment comprises pressing heads 11 and a power device slidably coordinating with the pressing heads 11. The pressing heads 11 is provided in pair, and one end of the pressing head is designed as open, the diameter of the opening end being greater than that of the reinforcing bars 3 to be connected and smaller than that of the tail end 2-2 of the tapered sleeve. The power device coordinating with the pressing heads 11 comprises a guide rail 12, a lead screw 13, a worm gear 14 and a worm rod 15. The pressing head 11 coordinates with the guide rail 12 and can move back and forth along the guide rail 12. One end of each of the pressing head 11 near the guide rail 12 is provided with threads, the directions of the threads on the two pressing heads 11 are opposite, and the pressing heads coordinate with the lead screw 13 to form leadscrew-and-nut pairs. Both ends of the lead screw 13 are provided with positive and negative trapezoidal threads, respectively, one end of the lead screw 13 is fixedly connected with the worm gear 14, the worm gear 14 coordinate with the worm rod 15 to form the wormgear-and-wormrod pair. One end of the worm rod 15 is provided with the square head, which can coordinate with a manual, pneumatic or electric wrench.

The method of connecting the reinforcing bars using the tapered sleeve locking type reinforcing bar connecting joint as described in Embodiment 1 and the mounting tool as described in this embodiment is as follows: (1) the two tapered sleeves 2 are fitted over the ends of the reinforcing bars 3 to be connected, respectively, with the front ends 2-1 of the tapered sleeves oppositely arranged, then the ends of the reinforcing bars 3 to be connected covered with the tapered sleeves 2 are inserted in both ends of the locking sheet set 1, so that the ends of the reinforcing bars 3 to be connected is snapped at the boss 1-2 on the inner surface of the locking sheet set 1, and then the tapered sleeves 2 are made to cover the locking sheet set 1 for fixing; (2) the pressing heads 11 of the mounting tool of the present embodiment are fitted over the reinforcing bars 3 to be connected, and once positioned, the worm rod 15 is rotated through a manual, pneumatic or electric wrench, driving the worm gear 14 and the lead screw 13 to rotate, and then by means of the transmission of the leadscrew-and-nut pairs, the pressing heads 11 produce axial compression movement and approach to each other, applying axial compression force to the tail ends 2-2 of the tapered sleeves for compressing, making the tapered sleeves 2 at two sides move axially to shorten the spacing, until satisfying the design requirement, and the locking sheet set 1 tightens up and is snapped at the reinforcing bars 3 to be connected, and fixation between the locking sheet set 1 and the tapered sleeves 2 is also realized by inclined-plane self-locking principle; and (3) the worm rod 15 is rotated reversely, making the pressing heads 11 move away from each other, and the mounting tool of this embodiment is removed, the firm degree of the connection between the reinforcing bars is checked, thus completing the connection of two reinforcing bars.

What is claimed is:

1. A tapered sleeve locking type reinforcing bar connecting joint, characterized in that it comprises a locking sheet set and tapered sleeves, the locking sheet set is as a whole in shuttle shape and is provided therein with a tooth groove for locking, the tapered sleeves is provided in pair, with its inner chamber in tapered shape, and the pair of the tapered sleeve is symmetrically mounted around the locking sheet set.

2. The tapered sleeve locking type reinforcing bar connecting joint according to claim 1, characterized in that the locking sheet set is further provided with a boss therein.

3. The tapered sleeve locking type reinforcing bar connecting joint according to claim 2, characterized in that the boss is arranged on the centre position of the inner surface of the locking sheet set.

4. A mounting tool for mounting the tapered sleeve locking type reinforcing bar connecting joint according to claim 1, characterized in that it comprises pressing heads and a power device fixedly connected or slidably coordinating with the pressing heads, the pressing heads is provided in one pair, and one end of the pressing head is designed as open, the diameter of the opening end being greater than that of the reinforcing bars to be connected and smaller than that of the tail end of the tapered sleeve.

5. The mounting tool according to claim 4, characterized in that the power device fixedly connected with the pressing heads comprises a hydraulic controlling mechanism and a pulling rod, and the hydraulic controlling mechanism and the pulling rod are fixedly connected as one unity and fixedly provided between the other ends of the two pressing heads.

6. The mounting tool according to claim 5, characterized in that the hydraulic controlling mechanism comprises a hydraulic cylinder and a return spring, one end of the return spring is fixed to the bottom of body of the hydraulic cylinder, the other end thereof is fixed to one end of a piston of the hydraulic cylinder, and the pulling rod is fixedly connected to the other end of the piston of the hydraulic cylinder.

7. The mounting tool according to claim 6, characterized in that the hydraulic cylinder is provided with one inlet-outlet opening for hydraulic oil.

8. The mounting tool according to claim 5, characterized in that the hydraulic controlling mechanism is a hydraulic cylinder providing with two inlet-outlet openings for hydraulic oil, and the pulling rod is fixedly connected to one end of a piston of the hydraulic cylinder.

9. The mounting tool according to claim 4, characterized in that the power device coordinating with the pressing heads comprises a guide rail, a lead screw, a worm gear and a worm rod, the pressing heads coordinate with the guide rail and can move back and forth along the guide rail, one end of each of the pressing head near the guide rail is provided with threads, the directions of the threads on the two pressing heads are opposite, the pressing heads coordinate with the lead screw to form leadscrew-and-nut pairs, both ends of the lead screw are provided with positive and negative trapezoidal threads, respectively, one end of the lead screw is fixedly connected with the worm gear, and the worm gear coordinates with the worm rod to form wormgear-and-wormrod pair.

10. The mounting tool according to claim 9, characterized in that one end of the worm rod is provided with a square head.
